(19) United States
(12) Patent Application Publication
(10) Pub. No.: US 2009/0057503 A1
(43) Pub. Date: Mar. 5, 2009

(54) GOLF CLUB STAND ASSEMBLY

(76) Inventor: Wen-Sun Hou, Westlake Village, CA (US)

Correspondence Address: JOSEPH SWAN, A PROFESSIONAL CORPORATION, 1334 PARKVIEW AVENUE, SUITE100, MANHATTAN BEACH, CA, 90266, US

(21) Appl. No.: 11/847,247

(22) Filed: Aug. 29, 2007

(51) Int. Cl. F16M 11/22

(52) U.S. Cl. 248/165

(57) ABSTRACT

Provided are, among other things, systems, methods and techniques for assembling an elevated stand, in which is obtained a platform assembly having a number of legs and a number of golf clubs, each golf club having a distal end for a golf club head and a proximal end that includes a small opening. A stand is constructed by inserting each of the legs into the small opening in a different one of the golf clubs, and the stand is positioned so that the distal ends of the golf clubs rest on a supporting surface.

### FIELD OF THE INVENTION

The present invention pertains to a stand, such as a tripod, formed using golf clubs, as well as to methods for assembling such a stand.

### BACKGROUND

A variety of different devices and systems for helping a golfer to improve his or her golf game exist. With the arrival of relatively inexpensive video-recording devices, such as camcorders, more and more athletes have been recording their performance (or having their performance recorded) for later evaluation, either by themselves or by a coach. However, the present inventor has discovered that recording one's own performance when golfing alone often is difficult and cumbersome.

### SUMMARY OF THE INVENTION

The present invention addresses this problem by, among other things, providing devices and methods with which a golfer can assemble a stand from several golf clubs. In the preferred embodiments, such a stand is implemented as a camera tripod, having legs that predominantly are golf clubs.

Thus, in one aspect the invention is directed to systems, methods and techniques for assembling an elevated stand, in which is obtained a platform assembly having a number of legs and a number of golf clubs, each golf club having a distal end for a golf club head and a proximal end that includes a small opening. A stand is constructed by inserting each of the legs into the small opening in a different one of the golf clubs, and the stand is positioned so that the distal ends of the golf clubs rest on a supporting surface.

By virtue of the foregoing arrangement, it often will be possible for a golfer to quickly and easily set up an elevated stand with the use of a relatively small device and several golf clubs that already are present in his or her bag. As a result, an elevated stand can be assembled without having to carry around a large additional device, such as a tripod. As noted above, in the preferred embodiments of these stand is used as a camera tripod. However, such a stand can be used for a variety of other purposes, such as for holding a towel.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 illustrates a stand in use as a camera tripod for recording a golfer's swing.

FIG. 2 is a perspective view of a platform assembly, with its legs substantially parallel to each other, exploded out from the golf clubs into which such legs are inserted to form a stand.

FIG. 3 is a perspective view of a stand according to the present invention, implemented as a camera tripod.

FIG. 4 is a cross-sectional view of a portion of a platform assembly leg inserted into the top portion of a golf club.

FIG. 5 is a perspective view of a stand having an attached receptacle for a portable electronic device.

FIG. 6 is a perspective view of a stand having an alternate pivoting mechanism.

FIG. 7 is a flow diagram of a method for constructing a stand.

### DESCRIPTION OF THE PREFERRED EMBODIMENT(S)

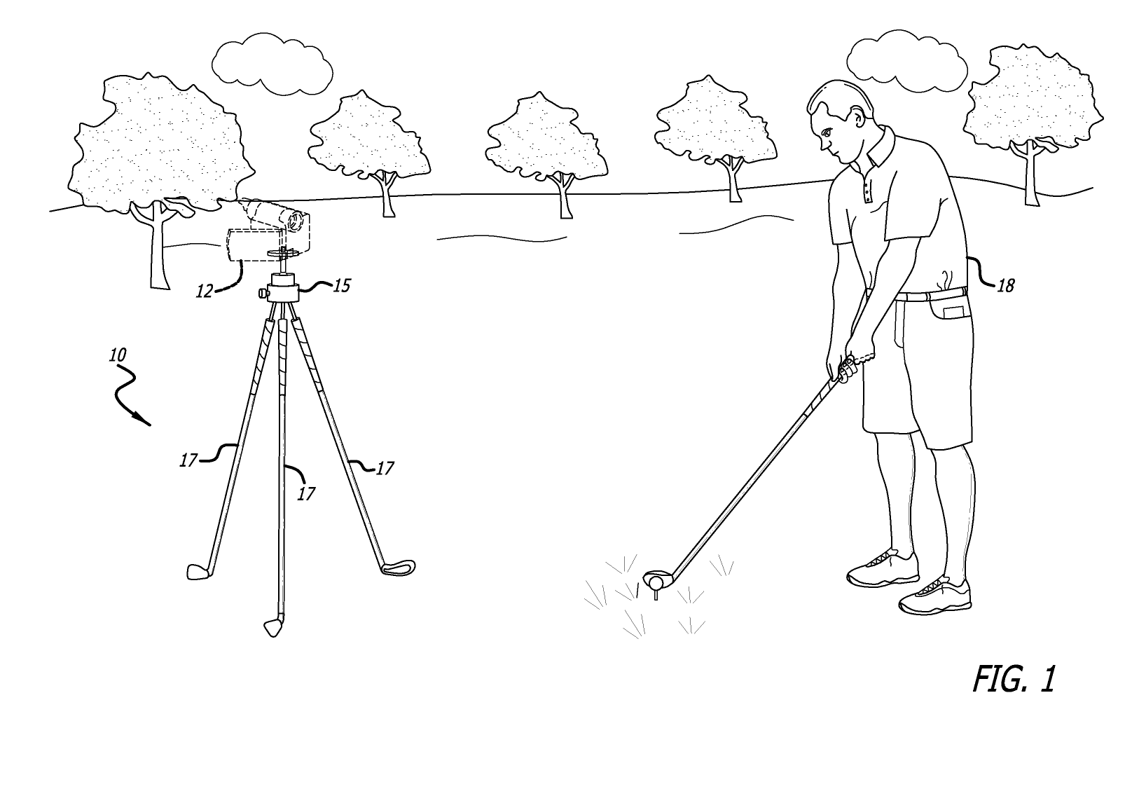

FIG. 1 illustrates one example of the use of a stand 10, according to a representative embodiment of the present invention. Here, stand 10 is implemented as a tripod for supporting a video-recording device 12, such as a camcorder. However, as will be apparent below, stand 10 also can be used to support a still-image camera, a camera that takes and/or records both still images and video, or any other device. As shown, stand 10 includes a platform assembly 15 and a plurality of golf clubs 17, with the golf clubs 17 constituting most of the length of the legs for stand 10 (three such legs in this embodiment).

In the present use, video-recording device 12 is used to record the golf swing for a user 18. As described in more detail below, in the preferred embodiments of the invention the user 18 can quickly and easily set up a stand 10 using golf clubs 17 that he or she already has, together with a small platform assembly 15, rather than carrying a much larger camera tripod.

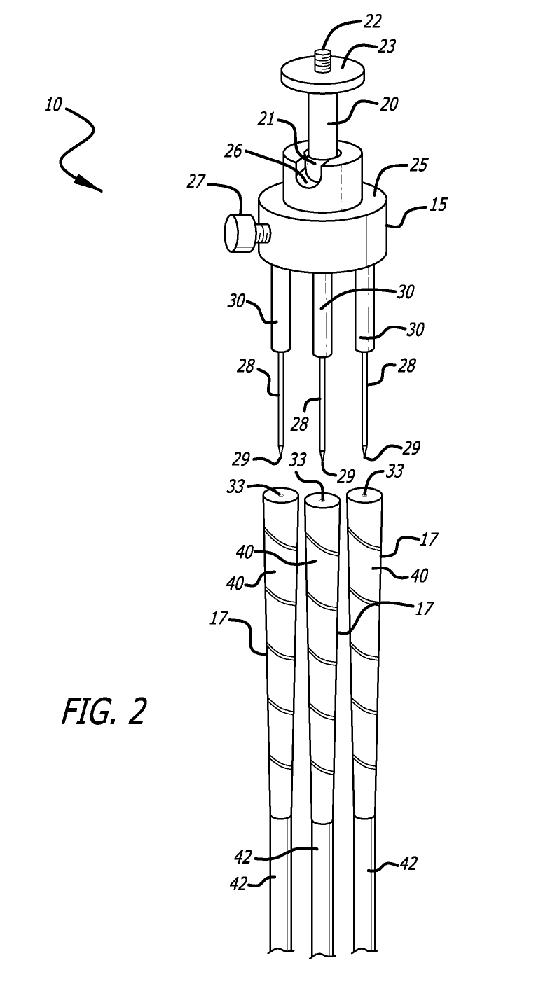

FIG. 2 shows the stand 10 in greater detail and illustrates how the platform assembly 15 is attached to the golf clubs 17. In the present embodiment, platform assembly 15 includes an upper portion 20 and a base portion 25, with the upper portion 20 being capable of pivoting (or tilting) relative to the base portion 25. More specifically, in the present embodiment such pivoting (or tilting) is accomplished using a ball joint, with the upper portion 20 including a ball 21 and the base portion 25 including a socket (not separately shown) into which ball 21 is disposed. As a result, the pointing direction of the video-recording device 12 can be quickly and easily adjusted in a variety of different directions and, using notch 26, can even be pointed at a 90° angle relative to the platform assembly 15 (and, accordingly, the entire stand 10). A screw 27 preferably is provided and can be tightened to lock the ball 21 into place (i.e., to inhibit movement of the ball 21 and the rest of upper portion 20 relative to the socket and the rest of base portion 25) or loosened to permit the ball 21 to move relative to the socket, thereby permitting adjustment of the entire upper portion 20 relative to the base portion 25.

In the present embodiment, the upper portion 20 includes a threaded male member 22 that engages with the threaded female member that is provided in standard conventional still-image and/or video cameras. That is, the threaded male member 22 preferably is identical to corresponding threaded male members provided on standard conventional camera tripods. Also similar to standard conventional camera tripods, upper portion 20 preferably includes a flat surface 23 upon which the video-recording device 12 (or other type of camera) can rest, and which also functions as a mechanism for tightening the upper portion 20 to the device 12 (or other type of camera).

Attached to the base portion 25 of the platform assembly 15 (preferably, pivotally attached) are a plurality of legs 28 (three in the present embodiment). As shown in FIG. 2, the legs 28 preferably are capable of being positioned such that they extend substantially straight down (so that they are all substantially parallel to each other). In this position, the legs 28 preferably are inserted into corresponding golf clubs 17. More specifically, each of the golf clubs 17 preferably includes a small hole 33 in its proximal end (the distal end having the golf club head). It is noted that such a hole 33 is provided at the end of most or all conventional golf club grips 40, so as to provide a way for air within the grip 40 to exit when the golf club grip 40 is slid onto the golf club shaft 42. The golf club shaft 42 itself typically is hollow.

The distal ends 29 of the legs 28 preferably are pointed so as to allow legs 28 to puncture the tape that typically is wrapped around the golf club shaft 42 prior to installing the grip 40. For safety purposes, end caps (not shown) preferably are provided to cover the distal ends 29 of legs 28 when platform assembly 15 is not in use.

In addition, the legs 28 preferably are small enough in diameter to fit through the holes 33. That is, legs 28 preferably are not more than 5 mm (millimeters) wide (e.g., in diameter, assuming a circular cross-section) and, more preferably, are not more than 4 mm wide. At the same time, legs 28 preferably are configured to provide adequate strength. For this purpose, legs 28 preferably are at least 2-3 mm wide and are made of steel. More preferably, legs 28 are approximately 3 mm wide.

Finally, legs 28 preferably are fairly short, e.g., from 2-8 cm (centimeters) long. Moreover, the entire length of platform assembly 15 preferably is less than 15 cm and, more preferably, approximately 12 cm and is light (e.g., primarily made of plastic or aluminum and/or less than 60 g (grams) in mass). As a result, the entire platform assembly 15 preferably is relatively small and easy to carry around, such as in a pocket of the user's golf club bag, or even in a shirt, jacket or trouser pocket.

A stop 30, close to the proximal end of each of the legs 28, prevents the leg 28 from inserting for its full length into a corresponding golf club 17. That is, stop 30 is significantly wider than hole 33. As a result, the leg 28 has some clearance between its proximal end and the proximal end of the golf club 18, thereby facilitating pivoting of the leg 28. Also, legs 28 preferably are rigid and non-telescoping along their entire length.

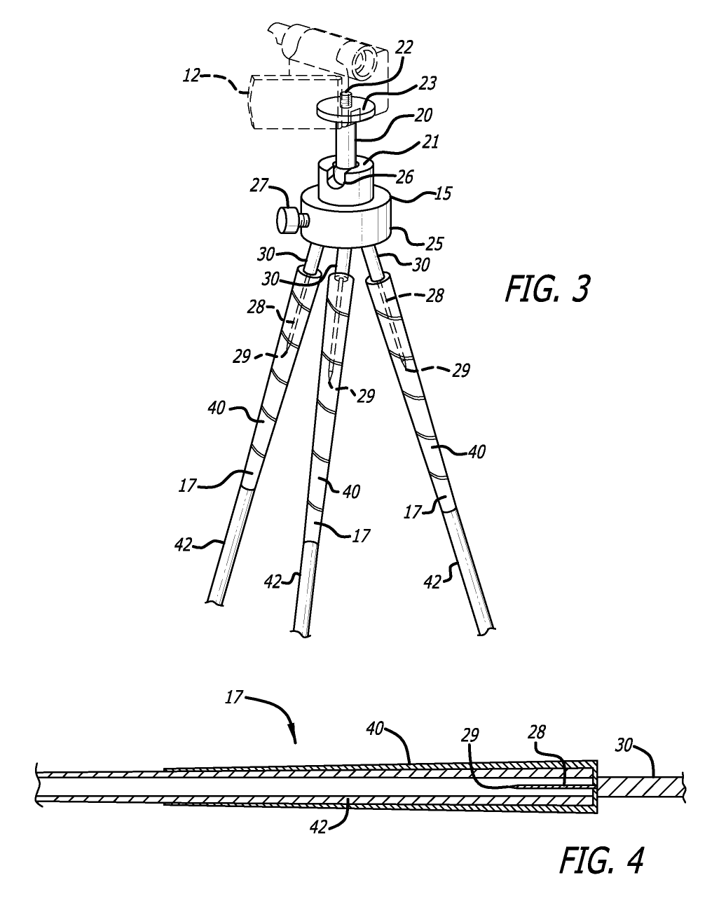

FIG. 3 is a perspective view of a stand 10, showing platform assembly 15 with a camcorder 12 installed on the threaded male member 22 of the upper portion 20 and with the legs 28 of the base portion 25 inserted into three separate golf clubs 17 up to the corresponding stops 30. In addition, as shown in FIG. 3, the legs 28, as well as the golf clubs 17 to which they have been attached and the stops 30, have been pivoted outwardly to form a tripod.

It is noted that each of the legs 28, together with its corresponding stop 30, preferably is capable of pivoting (preferably, within a single plane), at its attachment point to the remainder of base portion 25, from a first position in which the legs 28 (and stops 30) are substantially parallel to each other (as shown in FIG. 2) to a second position in which each of the legs 28 (and stops 30) is at least 10-45 degrees from its orientation in substantially parallel position. For example, any conventional pivoting mechanism (e.g., any leg-pivoting mechanism used in a conventional camera tripod) can be used for this purpose.

FIG. 4 is a cross-sectional view of a platform assembly leg 28 inserted into the top portion of a golf club 17 up until the stop 30. As noted above, the leg 28 passes through hole 30 (not shown in FIG. 4) in golf club grip 40 and remains disposed within the shaft 42 of golf club 18.

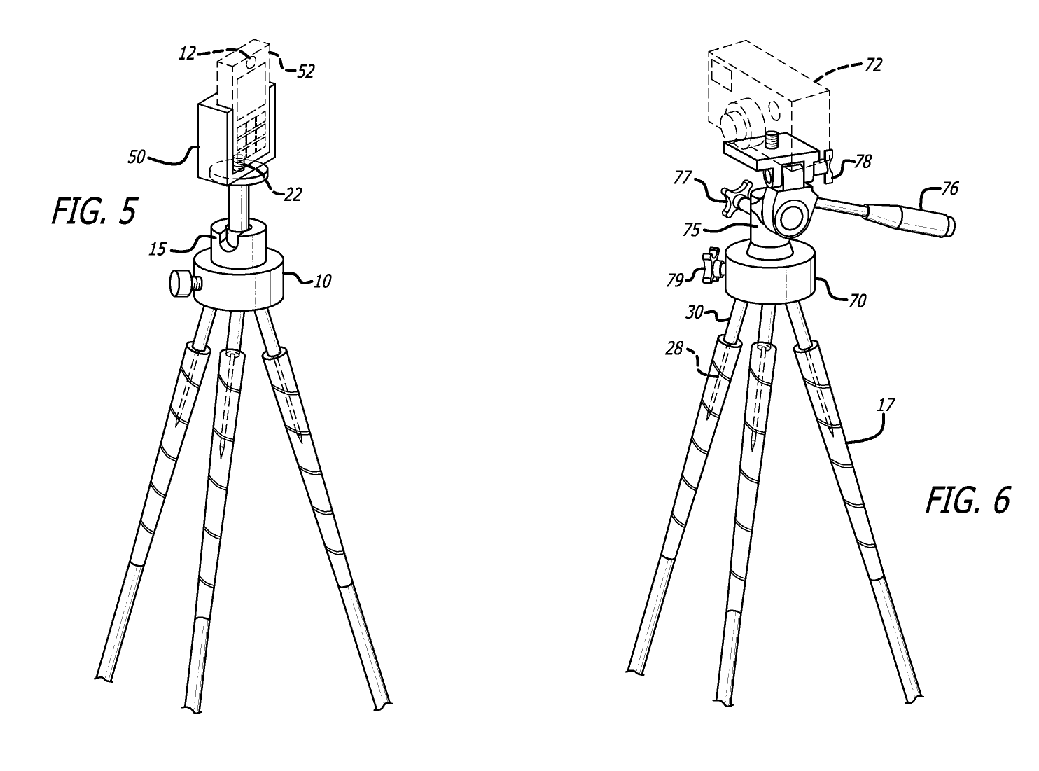

FIG. 5 is a perspective view of a stand 10 having an attached receptacle 50 for a portable electronic device 52 that includes a built-in video-recording device 12 or other kind of camera (i.e., the camera is integrated with other functionality). For example, portable electronic device 52 can include a wireless phone or a personal digital assistant (PDA), as well as a video-recording device or other kind of camera. In the present embodiment, receptacle 50 includes a mating threaded female member (not shown) for engaging with threaded male member 22 of platform assembly 15. Accordingly, receptacle 50 can be easily removed and attached to another stand or to a conventional camera tripod.

Preferably, a portable electronic device 52 simply can be inserted into (or otherwise secured to) receptacle 50, which is then screwed onto a stand or conventional camera tripod; alternatively, the receptacle 50 is first screwed onto the stand or conventional camera tripod and then the portable electronic device 52 is inserted into, or otherwise secured to or within (e.g., using a hook-and-loop mechanism, such as it is commonly sold under the trademark Velcro™), receptacle 50. In these embodiments, receptacle 50 functions as an adapter, allowing a wireless telephone or other portable electronic device 52 to be used on certain stands according to the present invention, or on a standard conventional camera tripod or stand. However, in alternate embodiments, receptacle 50 is removably attached to a stand (e.g., a stand according to the present invention) in any other manner. Still further, in some embodiments, receptacle 50 is more or less permanently attached to the stand.

In any event, receptacle 50 preferably is sized and shaped to accommodate portable electronic device 52. In certain embodiments (e.g., where the receptacles 50 are made from a plastic material), different receptacles 50 are used for different models of portable electronic devices 52, so that each receptacle 50 securely retains its corresponding portable electronic device 52 once the device 52 has been inserted into it (e.g., by sliding device 52 into an opening at the top of receptacle 50) or otherwise secured within or to it. In other embodiments (e.g., where a receptacle 50 is made of a stretchy, fabric or similar soft material, and/or where it is provided with hook-and-loop or other kinds of tightening straps), a single receptacle 50 can be used for a variety of different models of portable electronic devices 52. In any event, each receptacle 50 preferably is made available as an accessory for the corresponding portable electronic device 52.

FIG. 6 is a perspective view of a stand 70, which is identical to stand 10 except that stand 70 uses a platform assembly 75 having an alternate pivoting mechanism. Specifically, in platform assembly 75 rotation is separately controlled in each of the three dimensions. When knob 77 is loosened, the camera 72 (which can take still images or video) can be pointed downwardly, straight ahead or upwardly, e.g., using handle 76. When knob 79 is loosened, the camera 72 can be rotated to any position between the horizontal orientation (for landscape pictures) and the vertical orientation (for portrait pictures). When knob 79 is loosened, camera 72 can be pointed to any position from left to straight ahead to right.

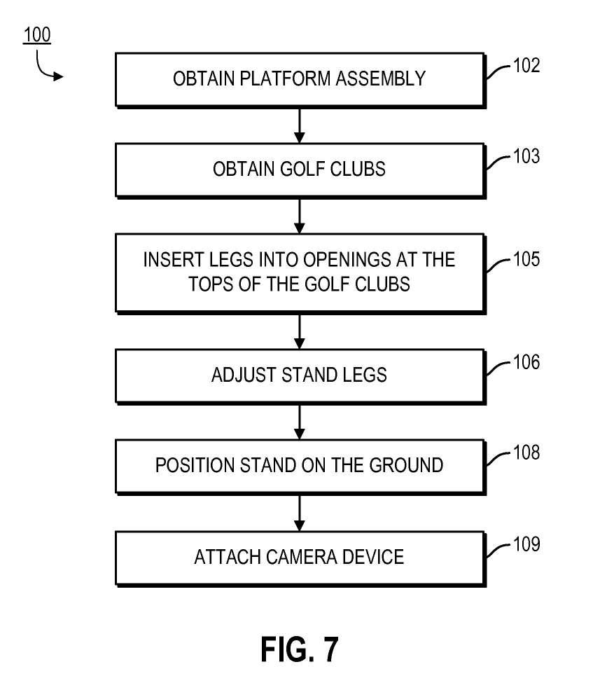

FIG. 7 is a flow diagram of a method 100 for constructing a stand according to a representative embodiment of the present invention. As indicated below, although the steps of method 100 are shown in a particular order, in general, the sequence can be rearranged in any desired order.

Initially, in step 102 a platform assembly (such as platform assembly 15 or 75) is obtained. For purposes of the present discussion, it is assumed that platform assembly 15 is used.

In step 103, a number of golf clubs 17, preferably corresponding to the number of legs 28 of the platform assembly 15, is obtained. Also, in the preferred embodiments, each such golf club 17 includes a hole or opening 33 at its top or proximal end.

In step 105, each of the legs 28 is inserted into the opening 33 for a corresponding one of the golf clubs 17. If no such opening 33 has been provided in the golf clubs 17, an opening 33 preferably is formed in each such golf club 17 by using the preferably pointed end 29 of the leg 28 to puncture the proximal end of the golf club 17 as the leg 28 is inserted into the golf club 17. In the preferred embodiments, the step 105 is performed while the legs 28 are pointing substantially downwardly (i.e., while the legs 28 are substantially parallel with each other). The result of this insertion is to create the stand 10. It is noted that prior to the step 105, any safety caps at the distal ends 29 of the legs 28 preferably are removed.

In step 107, any desired adjustment of the stand legs (i.e., the combination of legs 28 and the golf clubs 17 into which they are inserted) is performed. For example, if the legs 28 are inserted while substantially parallel to each other, then the stand legs preferably are spread apart so as to form a stable tripod.

In step 108, the stand 10 is positioned so that the distal ends of the golf clubs 17 rest on the ground or other supporting surface, such as is shown in FIG. 1.

In step 109, a camera device is attached to the platform assembly 15. As indicated above, this step 109 preferably is performed by threading male member 22 into a corresponding female member in a camcorder, still-image camera (which typically also will be capable of recording video) and/or a receptacle 50 for holding some other device that includes a camera, such as a cellular telephone or other portable electronic device 52. Although shown in FIG. 7 as occurring at the end of the process, it should be noted that this step 109 can in fact be performed at any point during the assembly method.

Once a stand 10 has been assembled and a camera attached in the foregoing manner, it is ready to use, e.g., for recording a golfer's swing.

### ADDITIONAL CONSIDERATIONS

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A method of assembling an elevated stand, comprising:
obtaining a platform assembly having a plurality of legs;
obtaining a plurality of golf clubs, each golf club having a distal end for a golf club head and a proximal end that includes a small opening;
constructing a stand by inserting each of the plurality of legs into the small opening in a different one of the plurality of golf clubs; and
positioning the stand so that the distal ends of the golf clubs rest on a supporting surface.

2. A method according to claim 1, wherein the platform assembly includes exactly three legs so that the stand is a tripod.

3. A method according to claim 1, wherein the legs are pivotally attached to the stand.

4. A method according to claim 3, wherein the legs are capable of pivoting from a first position in which the legs are substantially parallel to each other to a second position in which each of the legs is at least 10 degrees from its orientation in the first position.

5. A method according to claim 1, wherein the legs are from 2-8 cm (centimeters) long.

6. A method according to claim 1, wherein the legs are not more than 5 mm (millimeters) wide.

7. A method according to claim 1, wherein the legs are not more than 4 mm wide.

8. A method according to claim 1, wherein each of the legs has a distal end that is pointed.

9. A method according to claim 1, wherein each of the legs has a proximal end at which said each leg attaches to the platform assembly, and a stop is disposed close to the proximal end to prevent said each leg from inserting for its full length into one of the golf clubs.

10. A method according to claim 1, wherein the platform assembly includes a base portion and an upper portion that pivots relative to the base portion.

11. A method according to claim 10, wherein the upper portion pivots relative to the base portion using a ball joint.

12. A method according to claim 10, wherein the platform assembly further includes a locking mechanism to selectively inhibit pivoting of the upper portion relative to the base.

13. A method according to claim 1, wherein the legs are rigid and non-telescoping along their entire length.

14. A method according to claim 1, further comprising a step of securing a camera to the platform assembly.

15. A method according to claim 14, wherein the camera comprises a video recording device.

16. A method according to claim 14, wherein the camera is integrated with a wireless telephone.

17. A method according to claim 14, wherein the platform assembly includes a threaded male member that engages with a threaded female member in standard conventional cameras.

18. A method according to claim 14, further comprising a receptacle that is attached to the platform assembly and that is sized and shaped to receive and securely retain a particular electronic device that includes the camera.

19. A method according to claim 18, wherein the receptacle is readily detachable from the platform assembly.

20. A method according to claim 19, wherein the receptacle attaches to and detaches from the platform assembly using mated threaded members.
